(19) United States
(12) Patent Application Publication
(10) Pub. No.: US 2015/0052011 A1
(43) Pub. Date: Feb. 19, 2015

(54) Store product aisle locator system and method

(71) Applicant: Cheryl Bozek, Smock, PA (US)

(72) Inventor: Cheryl Bozek, Smock, PA (US)

(21) Appl. No.: 14/052,895

(22) Filed: Oct. 14, 2013

Related U.S. Application Data
(60) Provisional application No. 61/867,194, filed on Aug. 19, 2013.

(51) Int. Cl. G06Q 30/06

(52) U.S. Cl. CPC G06Q 30/0639
USPC 705/26.9

(57) ABSTRACT

A system and method for assisting a shopper in locating a product based on aisle number. A system console having a processor is network with a store computer, wherein the store computer includes a store database for tracking inventory as part of an existing inventory management system used by a store. The customer is allowed to input product information into the system console, wherein the product information includes a name of a product. The aisle number associated with the product is outputted to the customer such that the customer can proceed directly to an aisle at which the product is stored, thereby bypassing the need for radio-frequency identification tags specific to the product.

### CROSS-REFERENCE TO RELATED APPLICATIONS

The instant application claims benefit established by U.S. Provisional Application Ser. No. 61/867,194, filed Aug. 19, 2013, the disclosure of which is herein incorporated by reference.

### BACKGROUND

1. Field of the Invention

The invention relates to systems and methods for assisting shoppers in locating inventory. More specifically, the shopping assistance system herein operates to display, as output, an aisle number which directs the shopper to the aisle which matches up to the inputted inventory search.

2. Description of the Related Art

Known in the art are methods and systems within retail stores for allowing a consumer to verify prices. For example, U.S. Pat. No. 5,382,779 teaches a price verification method for retail stores using shelf pricing, and apparatus therefor, in which the shelf labels are provided with an extended bar code having the item number and price of the item. A remote unit scans the item number and price, and uses the item number to look up the item in a database which is identical to the store checkout scanner database, and compares the shelf price to the database price.

U.S. Pat. No. 7,014,116 shows a price verification device including a barcode scanner, an Optical Character Recognition (OCR) reader and an optional key pad. To verify a price for an item, a user such as a consumer will scan a barcode printed on a label associated with the item using the barcode scanner, and read the price for the item as printed on the label using the OCR reader.

Also taught are automated shopping lists which allow consumers to track products and expenditures. For instance, U.S. Pat. No. 5,424,524 describes a personal bar code scanning device for aiding shoppers in keeping track of their expenditures and speeding the process of check-out and taking advantage of coupons.

Additionally in the art are tracking systems and methods for locating grocery store products. For example, U.S. Pat. No. 7,762,458 is a media enabled shopping system coupled with a shopping cart having a monitor and tracking device, wherein a read component performs a proximity scan of the shopping cart, and a locating component determines a location of the shopping cart within a store based on a scan, and a display component determines a location of the product within the store relative to the shopping cart based on the scan, and wherein the display component is further operable to display an indication of the location of the advertised product relative to the location of the shopping cart. U.S. Publication No. 20100013662 is product locating system for use in e.g. store, which system locates selected products in a store using a computer module which has a keyboard and a visual display position and a plurality of position indicating devices, such as passive or active RFID devices, which are fixed to a shelf or to products on a shelf to indicate the location of the product.

The above systems are considerably complex and expensive. Moreover, required is the use of RFID tags and scanners which are implemented throughout the store shelves to transmit the location signals to the receiving component. As inventory management systems become more automated and, moreover, provided as Software-as-a-Service on servers which are remote from the actual inventor, the consumer and stores are presented with an opportunity to share inventory data and store mapping information at least on a minimum level, as provided herein.

### SUMMARY

It is the objective of the instant invention to provide a system and method which allows a consumer to search for a particular store product and be provided, as output, an aisle number/designator which will immediately direct the consumer to the appropriate store location.

Accordingly, the invention comprehends an electronic shopping assistance system communicating between a store database and a customer assistance terminal for providing a product aisle location for a consumer. The shopping assistance terminal operates as a product locator search terminal. Product locations are maintained in the store database, and as a search product is keyed into the customer assistance terminal, the item's location is displayed on an integral display screen.

More particularly, disclosed is a method for assisting a shopper, comprising the steps of: networking a system console having a processor with a store computer, wherein the store computer includes a store database for tracking inventory as part of an existing inventory management system used by a store; allowing a customer to input product information into the system console, wherein the product information includes a name of a product; outputting to the customer, via the system console, an aisle number associated with the product such that the customer can proceed directly to an aisle at which the product is stored thereby bypassing the need for radio-frequency identification tags specific to the product. The method further comprises the step of filtering data from the store database such that the only of the data presented as the product location information is the name and the aisle number. Additionally, the method further comprises the step of sorting the product location information when multiple of the products are inputted, wherein the product location information is outputted in an order allowing the shopper to proceed sequentially within the store.

### BRIEF DESCRIPTION OF THE DRAWINGS

FIG. 1 is a diagrammatic representation of the instant system as implemented.

FIG. 2 shows a flow chart depicting the prior art inventory management system.

FIG. 3 shows a flow chart depicting the instant method utilizing the inventory management system.

FIG. 4 shows a flow chart for the overall process.

### DETAILED DESCRIPTION OF THE PREFERRED EMBODIMENT

The flow charts and/or sections thereof represent a method with logic or program flow that can be executed by a specialized device or a computer and/or implemented on computer readable media or the like (residing on a drive or device after download) tangibly embodying the program of instructions. The executions are typically performed on a computer or specialized device (system console as defined herein) as part of a global communications network such as the Internet. For example, a computer typically has a web browser installed within the CPU for allowing the viewing of information retrieved via a network on the display device. A network may also be construed as a local, ethernet connection or a global digital/broadband or wireless network or cloud computing network or the like. The specialized device may include any device having circuitry or be a hand-held device, including but not limited to a tablet, smart phone, cellular phone or personal digital assistant (PDA). Accordingly, multiple modes of implementation are possible and “system” as defined herein covers these multiple modes.

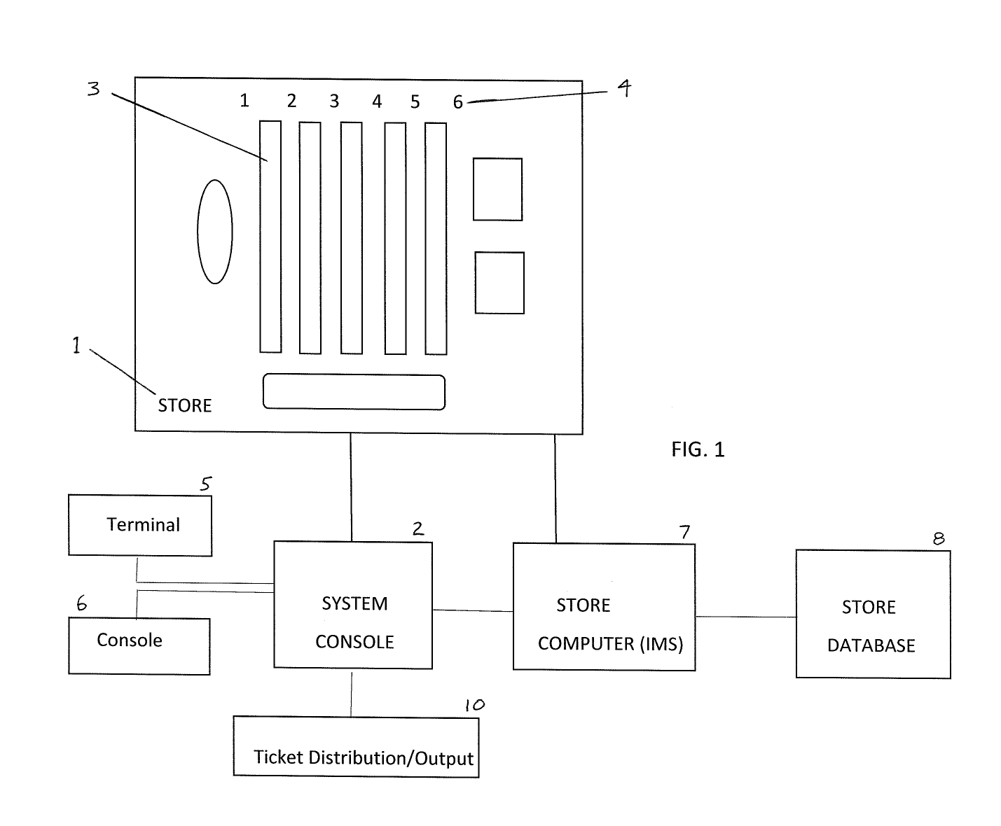

Referencing FIG. 1, residing in or around a store 1, for instance at or near the entrance to the store 1, inside or outside of the store 1, is a customer terminal 5 coupled to a console 6, referred herein collectively as system console 2. The store 1 can be any type of grocery, department store, or any retail store such as a hardware store or lumber center which traditionally would have a quantity of inventory that is laid out throughout the store 1 using a logical aisle-numbering scheme designating store aisles 3 with aisle numbers 4. A grocery store is described herein as an example only, diagrammatically illustrated as store 1 within FIG. 1. A terminal 5 means any a hardware device for data entry such as a touchpad, keypad, microphone, touchscreen, or mouse. Included in terminal can also be any means for printing. Console 6, interfaced to terminal 5, means an output device for display such as a monitor or screen. It should be understood that the system console 2 may be a temporarily piece of fixed equipment or reduced to a portable form which allows the consumer to carry the device, and in a further embodiment can be a mobile smartphone running a mobile software application (App). The App. may either implement the methodology herein or be used merely to display the output associated with the methodology, either of which would be programmed in a similar fashion as the system console 2 itself. Therefore, in either instance, system console 2, like a computer, is a programmable device including a processor for accepting input, processing the input according to instructions stored in memory, and providing resulting output.

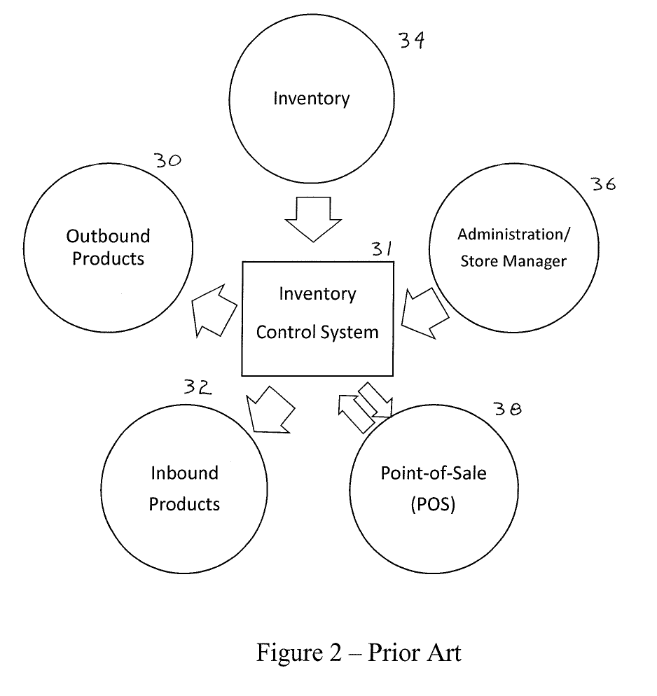

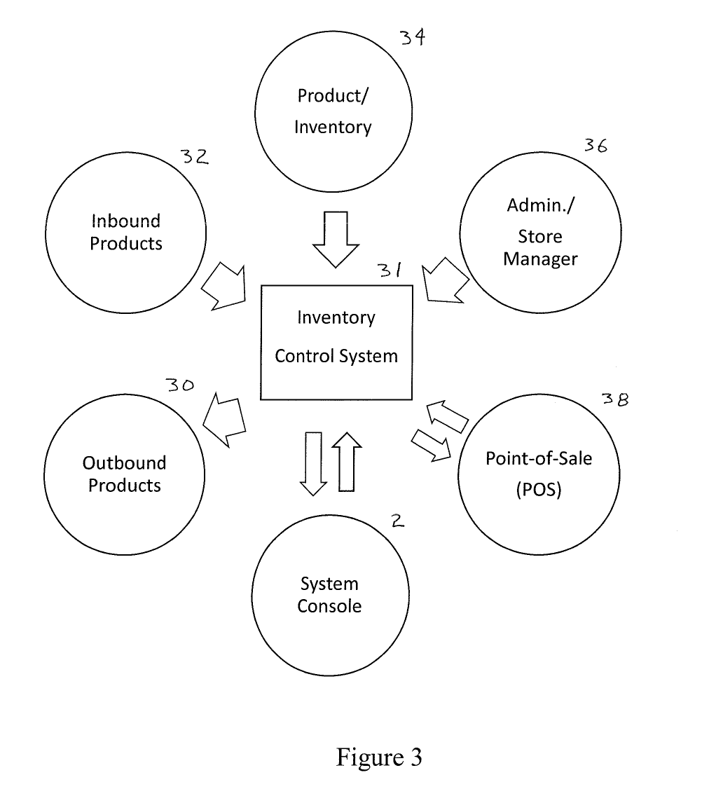

Referencing FIGS. 2-3 with continued reference to FIG. 1, system console 2 either has integrated therein or is network interfaced to store computer 7. Store computer 7 includes store database 8. The store computer 7 including store database 8 means the store system as would exist for storing and tracking inventory as part of its existing inventory management system (IMS) 31. “Existing” means a store's IMS as already-in place and already functioning or as can be modified (but still already in-place) to accommodate the instant methodology. Most companies use the IMS 31 as a software-based control system to automate functions related to shipping of inbound products 32, outbound products 30, product/inventory 34, general administration 36, and electronic physical inventory systems may provide a method for direct entry into the point of sale system 38 to track each item at the point of sale wherever possible. Since store computer's 7 IMS 31 maintains the database 8 of information on the products, for purposes of this invention the relevant information within database 8 relates to product or food inventory. In light of the network tie-in to the IMS 31, critical to this invention is that the system and method excludes the use of radio frequency identification tags (RFID), chips, and related RFID technology.

In typical inventory systems for retail stores, the set of store computer(s) 7 may be used locally to run the IMS. These are locally networked with perhaps a server located at the site of the retail store depending on the amount of inventory data of store database 8. The instant embodiment can be implemented within these IMS systems simply by networking into the IMS 31. However, as more IMS systems are moved to the “cloud” in the form of software provided as a service (SaaS), the easier and more cost-effective it is to tie into these IMS 31 systems as the SaaS-based IMS operates with the system console without the requirement of costly networking and maintenance. Additionally, since most businesses institute the inventory management system (within store computer 7) that allows them to accurately and effectively keep track of their inventory, in the preferred embodiment herein system console 2 communicates, by way of network, with the IMS 31 of store database 8, excluding RFID tags but also excluding the need to output all of the confidential inventory information since all that is desired is the product location information. A filter can be employed by the computer program or routine to process the IMS data stream and exclude all inventory database except the product location information. In turn, since sales floors are also diagrammed using the IMS 31, the system console 2 can output the sales floor information to the user if desirable, but herein in the condensed, user-friendly form of the aisle numbers 4 of any inputted query by the customer.

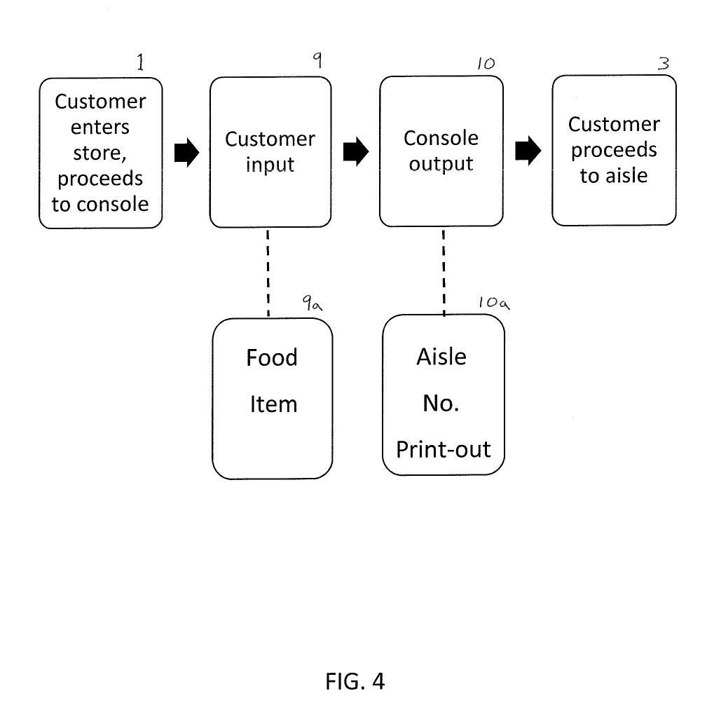

Now referencing FIG. 4 with continued reference to FIGS. 1-3, system console 2 therefore communicates between the store database 8 and the customer terminal 5 for providing a product aisle location for a consumer. Product aisle location means, as console output 10, in one embodiment, a print-out 10a of the food item 9a and aisle number 4 associated with the inputted food query input by consumer (customer input 9). In one embodiment the print-out 10a as console output 10 is implemented as a ticket comprised of thermal receipt paper such as the same receipt printed by cash registers. Consumer inputs into console ex: chocolate syrup. The system shows several choices such as Hershey syrup, pancake syrup, ice cream topping, etc. Upon selection of the desirable item, the ticket is printed with the item listed and the aisle number 4. As above, any type of input device or touch-screen technology can be employed for inputting.

In the event the consumer needs to locate multiple items, CONTINUE is an option. Once DONE, a sorting function is implemented such that the ticket then prints a list in numerical order with item locations so the consumer may shop sequentially without going in circles repeating his or her foot path. So “sequentially” means in an order which allows the shopper to proceed through the store in an efficient manner without back-tracking. For example, with reference back to FIG. 1, if system console 2 is at the front-right of store 1, if input is apples, milk, and soup, and produce is in or near aisle 6, diary is in aisle 1, and canned soups in aisle 4, the output may show apples: 6, soup: 4, milk: 1. Since system console 2 is tied into the IMS 31 and the sales floor information, the order of the aisle numbers presented as output may vary depending on the location of the system console 2 within store 1. In other words the order of sequencing is depending upon system console 2 location. For example, if there are two entrances at opposite sides of the store 1, system console 2 with its sorting function may present one preferred sequence for the shopper beginning with the shopper proceeding to the left, whereas an alternative system console 2, being network based, would presented the opposite sequence. In the above example therefore, if the system console is at the front-left of the store 1, the output would read milk: 1, soup: 4, apples: 6 guiding the shopper to proceed in one direction generally to the right. This is made possible since each system console 2, being network-based, is identified on the network by name or IP address or any other identifier, and so its location within the store 1 is known.

The product aisle location information will contain, at a minimum, the designated aisle in which the inputted food item 9a is associated, just as the store database 8 includes the aisle information for inventory tracking purposes. Although not required, the product aisle location information may contain other information related to the item 9a, such as helpful hints, recipes, or coupon codes.

In a further embodiment of the console output 10, instead of a print-out 10a, the aisle number 4 is displayed on a consumer's smart phone using a mobile software application (App). The App communicates with the store systems and is automatically updated with the aisle-specific information associated to that particular store, then presents the aisle number 4 on the phone's display.

In use therefore, shopper enters store 1 and proceeds to the nearby terminal. Customer then inputs 9 into terminal of system console 2 a store product he/she is searching for. As console output 10, the product is displayed along with an aisle number associated with that product and displays the aisle number to the shopper. The aisle number can be printed as an aisle number print-out 10a such that the shopper can take the print-out 10a and proceed directly to the designated aisle. As a result the shopping assistance terminal operates as a product locator search terminal. Product locations are maintained in the store database, and as a search product is keyed into the customer assistance terminal, the item's location is displayed on an integral display screen, thereby aiding the shopper in product location such that the shopper need not manually search for the item “aisle-by-aisle” or seek the need for personal assistance.

I claim:

1. A system for assisting a shopper, comprising:
a system console having a processor, said system console residing in a store and communicating with a store computer, wherein said store computer includes a store database for tracking inventory as part of an existing inventory management system used by a store;
a means for inputting a name of at least one product into said system console; and,
a means for outputting to said shopper product location information including an aisle number associated with said product retrieved, via said processor, from said existing inventory management system, wherein said shopper is directed to said aisle number without the need for radio-frequency identification tags specific to said product.

2. The system of claim 1, further comprising a means for filtering data from said store database such that the only of said data presented as said product location information is said name and said aisle number.

3. The system of claim 1, further comprising a means for sorting said product location information when multiple of said products are inputted, wherein said product location information is outputted in an order allowing said shopper to proceed sequentially within said store.

4. A method for assisting a shopper, comprising the steps of:
networking a system console having a processor with a store computer, wherein said store computer includes a store database for tracking inventory as part of an existing inventory management system used by a store;
allowing a customer to input product information into said system console, wherein said product information includes a name of a product;
outputting to said customer, via said system console, an aisle number associated with said product such that said customer can proceed directly to an aisle at which said product is stored thereby bypassing the need for radio-frequency identification tags specific to said product.

5. The method of claim 4, further comprising the step of filtering data from said store database such that the only of said data presented as said product location information is said name and said aisle number.

6. The method of claim 4, further comprising the step of sorting said product location information when multiple of said products are inputted, wherein said product location information is outputted in an order allowing said shopper to proceed sequentially within said store.

7. The method of claim 6, wherein said order is dependent upon a location of said system console within said store.

8. The method of claim 4, wherein for the step of outputting, said aisle number is printed from said system console.

9. The method of claim 4, wherein for the step of outputting, said aisle number is displayed on said system console.

10. The method of claim 4, wherein for the step of outputting, said aisle number is displayed on a smartphone utilizing a mobile software application.
